(19) United States
(12) Patent Application Publication
(10) Pub. No.: US 2017/0200229 A1
(43) Pub. Date: Jul. 13, 2017

(54) METHOD AND SYSTEM FOR ANALYZING AND PREDICTING BIDDING OF ELECTRIC POWER GENERATION

(71) Applicant: Genscape Intangible Holding, Inc., Louisville, KY (US)

(72) Inventors: Christopher Price, Huntington, NY (US); Chris Seiple, Westport, CT (US); Deirdre Alphenaar, Prospect, KY (US)

(21) Appl. No.: 15/401,065

(22) Filed: Jan. 8, 2017

Related U.S. Application Data
(60) Provisional application No. 62/276,278, filed on Jan. 8, 2016.

(51) Int. Cl. G06Q 40/04; G06Q 50/06

(52) U.S. Cl. CPC G06Q 40/04; G06Q 50/06

(57) ABSTRACT

In a method and system for analyzing and predicting bidding of electric power generation, bid data is collected for a selected region. The bid data is preprocessed to decode the identity of the bidding entities and/or to remove erroneous or noisy data. External information, such as fuel prices, weather data, and/or generator outage data, is also collected. A bid prediction model is generated for one or more of the bidding entities from the bid data and the external information. External information is subsequently received, and the bid prediction model is applied to that current external information to predict future bids for one or more of the bidding entities. The predicted future bids are then reported.

### CROSS-REFERENCE TO RELATED APPLICATIONS

The present application claims priority to U.S. Patent Application Ser. No. 62/276,278 filed on Jan. 8, 2016, which is incorporated herein by reference.

### BACKGROUND OF THE INVENTION

The present invention relates to the analysis and prediction of bidding of electric power generation.

On a daily basis, electric power generating companies and generation owners (or “power generators”) bid their generating assets (or “power generating units”) into the electric power marketplace. Each participating power generator has a pre-established methodology for defining the units of power that can be generated by their generating assets at a particular cost. These units of generated power for which a power generator can bid are termed bid blocks. The amount of power (or “generation value”) in each bid block is dependent on how the power generator has assigned bidding blocks for their generating assets. Bid blocks are determined entirely at the discretion of the power generator, although the market Independent System Operator (ISO) (as discussed further below) reserves the right to make modifications to submitted bid blocks in order to ensure compliance with the ISO's submission rules. The ISO will take the bid blocks offered by all of the participating power generators to create a dispatch schedule that ensures maximum electric reliability at least cost. For further details about this process, reference is made to “Energy Primer, A Handbook of Energy Market Basics,” which is published by the Federal Energy Regulatory Commission (FERC).

A power generator will typically have an economic model based on various factors, such as fuel cost and a wide range of physical operating costs, which determine the cost of generation for each bid block associated with its generating assets. The frequency at which bids are entered into an electric power marketplace is dictated and managed by the market region operators. In the United States case, there are currently seven independent market regions, and thus, seven Independent System Operators (ISOs): (i) Pennsylvania, Jersey, Maryland Power Pool (PJM); (ii) Midwestern Independent Transmission System Operator (MISO); (iii) New York Independent System Operator (NYISO); (iv) Electric Reliability Council of Texas (ERCOT); (v) Independent System Operator of New England (ISONE); (vi) Southwest Power Pool (SPP); and (vii) California Independent System Operator (CAISO). A given portion of a generating asset is bid into one market region only. The process for registration and bidding practices associated with generating assets is managed and detailed by each ISO.

Each marketplace has a defined bid period for which a power generator is allowed to submit a unique set of bid blocks. This bid period can range from a day to a fifteen-minute interval. Power generators can change their offered bids (subject to market rules) from interval to interval. Market ISOs run both day-ahead and real-time markets, with the opportunity for power generators to modify their submitted bid blocks in the real-time auction based on the results of the day-ahead auction.

The structure of the bid data submitted to the marketplace varies between market regions; details on how the bid data is entered and then subsequently published in the various market regions is illustrated in Table A below.

TABLE A

| | Release | | Bid- | | | | | Min |
|---|---|---|---|---|---|---|---|---|
| | Date | Bid | MW | | | Interpolation | Start | Gen |
| Region | (Day) | Interval | Pairs | EconMin | EconMax | Option | Cost | Cost |
| PJM | 120+ | Daily | 10 | Min/ | Min/ | Yes | Cold/ | Yes |
| | | | | Avg/Max | Avg/Max | | Inter/Hot | |
| MISO | 90 | Hourly | 10 | Yes | Yes | Yes | No | Yes |
| NYISO | 90+ | Hourly | 12 | Yes | Yes | No | No | Yes |
| ERCOT | 60 | 15 min | 35 | Yes | Yes | No | Cold/ | Yes |
| | | | | | | | Inter/Hot | |
| ISONE | 120 | Hourly | 10 | Yes | Yes | No | Cold/ | Yes |
| | | | | | | | Inter/Hot | |
| SPP | 90 | Hourly | 10 | No | No | No | No | No |
| CAISO | 90 | Hourly | 25 | No | No | No | No | No |

Each power generator submits to the ISO a “bid curve” into the day-ahead market. The bid curve is a series of increasing bid amounts (in dollars/MWh) for increasing units (blocks) of generation offered in megawatts (MW). As mentioned above, the ISO will take the bid blocks offered by all of the participating power generators to create a dispatch schedule that meets its needs based on the ISO's day-ahead power demand (load) forecasts. In short, the ISO will start with lowest cost bids and dispatch generation at increasing cost until the projected demand level is met.

With respect to the creation of the dispatch schedule, an auction model may also be used to assign generation amounts to participating power generators to ensure that the electricity demand is met at the lowest possible cost given the bids of the power generators. A Dutch auction, for example, begins with a high price that is reduced, removing high-cost bid blocks, until there is no longer an excess of generation clearing the auction. All bid offers that are less than or equal to the clearing price, where generation meets the forecasted demand, are paid this clearing price to generate power. This strongly encourages generators to offer their electricity at the marginal cost of production, so that they are always clearing the auction and generating when they are break-even or profitable, and never generating when they would be operating at a loss.

In all market regions, the bid data associated with power generating assets becomes available in the public domain at some fixed interval after the bids have been submitted, pursuant to regulations (e.g., FERC regulations in the United States). This interval varies from a 60-day delay for publication in ERCOT to, for example, a greater than 120-day delay in PJM. In some cases, although the bid data is publicly available, the data is encoded in such a way as to mask the participating power generators and their generating assets, so that it is not possible to match bidding entities (i.e., power generators that are bidding power generating assets) to actual bids submitted by these entities. In any event, the bid data is eventually published, whether encoded or unencoded, and the historic collection of bid data contains a wealth of otherwise unavailable information on patterns of bidding, operations and asset cost and optimization characteristics for each participating power generator and fleets of co-owned or co-managed generating assets, which form the basic infrastructure allowing the electric power marketplaces to exist. Analysis of this bid data can thus be invaluable to market participants, and such analysis also provides greater market transparency.

### SUMMARY OF THE INVENTION

The present invention is a method and system for analyzing and predicting bidding in an electric power marketplace, in part, by combining bid data with other sources of public and proprietary information and data (such as power generation, supply and demand data) in order to: profile bid behavior by individual bidding entities; estimate and predict future bids; and provide alerts with respect to bidding irregularities, all in order to provide more transparent and improved electric power marketplace supply, transfer, and demand data to market participants and market monitoring entities.

An exemplary implementation of the method of the present invention commences with the collection of bid data of interest, which is then stored in a database.

After the collection of bid data of interest, there is a pre-processing of that bid data. In this regard, when bid data is published in the public domain, in some cases, a code is used to identify the bidding entity (i.e., a power generator that is bidding a power generating asset). In this way, the identity of the bidding entity is masked. Thus, one or more pre-processing routines are implemented in order to decode the identity of the bidding entities (power generating units) from the bid data and/or to remove erroneous or noisy data.

After all pre-processing routines have been completed, the result is a bid curve for each bidding entity.

In certain implementations of the present invention, it is then necessary to normalize bid curves among all of the bidding entities in a region.

After all pre-processing routines have been completed and the bid curves have been normalized (if necessary), the next step is to generate a bid prediction model. The bid prediction model results from an analysis of the bid curves, combined with certain other data inputs. In practice, the bid prediction model is thus comprised of one or more equations, rules-based calculators, or rules-based reference tables which relate external information, such as fuel prices, weather data, and/or generator outage data, to bid prices and generation values.

Subsequently, current external information (e.g., fuel prices, weather information, and/or outage information) is received and input into the one or more bid prediction models for the various bidding entities. Each bid prediction model is applied to the current information to predict future bids for one or more bidding entities. The resulting bid predictions are stored for further analysis or reported to market participants.

As a further refinement, since the bid prediction models may be continuously re-generated, updated, and improved as new data and information is collected, it is also contemplated that changes in bidding patterns and bidding strategies for bidding entities can be identified and reported to market participants.

The above-described operational and computational steps of this method are preferably achieved through the use of a digital computer program (i.e., computer-readable instructions executed by a processor of a computer) that includes appropriate modules for executing the requisite instructions (which are stored in a memory component of the computer). Thus, an exemplary system for analyzing and predicting bidding in an electric power marketplace in accordance with the present invention includes: (a) a bid data receiving module for collecting and receiving bid data, which is then stored in a database; (b) a pre-processing module for decoding the identity of the bidding entities from the bid data and/or to remove erroneous or noisy data; (c) a bid data normalization module for normalizing bid curves among all of the bidding entities in a region, if necessary; (d) an information receiving module for collecting and receiving external information relevant to the bid data, including, for example, fuel prices, weather information (temperature), outage information, and/or any other information or data that might impact bidding strategies, which is also stored in a database; (e) an analysis module for (i) generating a bid prediction model from the bid data combined with the external information received via the information receiving module, and (ii) applying the bid prediction model against information that is subsequently received via the information receiving module to predict future bids for one or more bidding entities; and (f) a reporting module for reporting future bids for one or more bidding entities to market participants.

### DESCRIPTION OF THE DRAWINGS

FIG. 1 is a flow chart depicting the general functionality of an exemplary implementation of the method of the present invention;

FIG. 2 is a flow chart depicting the application of one or more bid prediction models, which are the output from the flow chart of FIG. 1, to predict future bids for one or more bidding entities;

FIG. 3 is an illustration of an exemplary bid curve;

FIG. 4 is a plot of the bid block prices against fuel prices, which is used in generating an exemplary bid prediction model;

FIG. 5 is a plot of bid block generation values against temperature, which is used in generating another exemplary bid prediction model; and

FIG. 6 is a schematic representation of the core components in the exemplary implementation of FIG. 1.

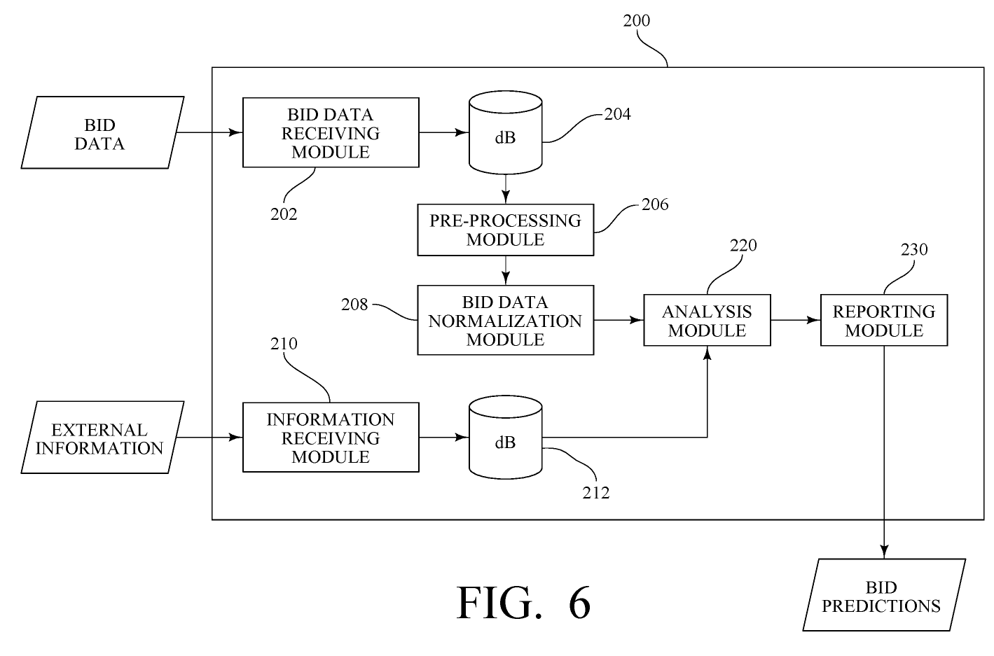

### DETAILED DESCRIPTION OF THE INVENTION

The present invention is a method and system for analyzing and predicting bidding in an electric power marketplace, in part, by combining bid data with other sources of public and proprietary information and data (such as power generation, supply and demand data) in order to: profile bid behavior by individual bidding entities; estimate and predict future bids; and provide alerts with respect to bidding irregularities, all in order to provide more transparent and improved electric power marketplace supply, transfer, and demand data to market participants and market monitoring entities. When the analysis of bid data is used in combination with real-time monitoring of generating and transmission assets, the sudden loss or disruption of these assets can be quantified in terms of the effect of their loss on the price of generated power needed to meet real-time demand in the marketplace.

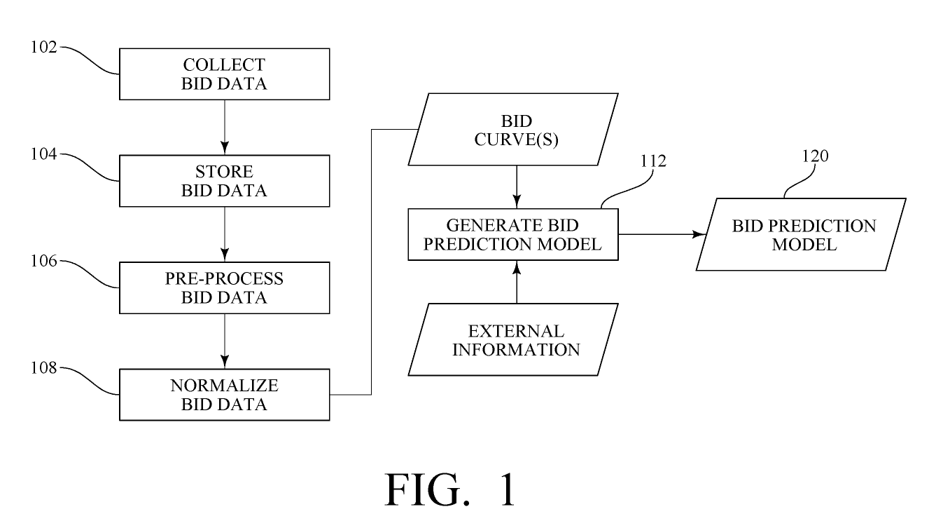

Referring now to FIG. 1, an exemplary implementation of the method of the present invention commences with the collection of bid data of interest, which, as described above, is typically publicly available, as indicated by block 102 of FIG. 1. Such bid data is then stored in a database, which is resident in a memory component of a computer, as indicated by block 104 of FIG. 1.

Referring still to FIG. 1, after the collection of bid data of interest, there is a pre-processing of that bid data, as indicated by block 106 of FIG. 1. Specifically, as mentioned above, for each independent market region, bid data is typically published in a manner shown in Table A above. As shown in Table A, a bid is submitted for a defined quantity of generated power or a block of generation, and these blocks are typically expressed in units of megawatts (MW) that can be produced, while the bid price is expressed in units of dollars ($). The format by which each market participant submits bid data is defined by the ISO for that independent market region.

Furthermore, when bid data is published in the public domain, in some cases, a code is used to identify the bidding entity (i.e., a power generator that is bidding a power generating asset). In this way, the identity of the bidding entity is masked. In addition to the actual market submitted bids, other information is published which can be useful in the analysis of the bidding information, including, for example, the amount a power generator bids per block of generation, which is decided based on internal economic models used to operate the power generating assets. For additional examples, inputs such as fuel, run-time, maintenance and other costs, as well as operational characteristics of the power generating assets, may also be published. For instance, the Economic Minimum (“EconMin”), Economic Maximum (“EconMax”), Minimum Generator Cost (“Min Gen Cost”), and Start-up Costs (“Start Cost”) may be published. EconMin is the minimum sustainable level that the power generator must operate at to form the base of an increasing cost curve (where the cost curve outlines the increasing costs for increased generation production). EconMax is the maximum generating level that the generator can sustain without causing non-economically viable damage to the generating asset. Min Gen Cost is the cost of running a generating unit at its economic minimum output level, and Start Cost is the cost of bringing a generating unit from an offline state to an operating state at an economically minimum sustainable level.

Thus, one or more pre-processing routines are implemented in order to decode the identity of the bidding entities from the bid data and/or to remove erroneous or noisy data. For example, as part of such pre-processing, bid/block pairs where both the bid amount ($) or the generation value (MW) are equal to zero may be eliminated. For another example, the bid data may be then checked and ordered to ensure that both the bid amounts ($) and the generation values (MW) are a monotonically increasing series. For another example, outliers, such as bid blocks where the generation value exceeds the stated maximum economically viable amount (i.e., the economic max) or the generation value is lower than the minimal economical amount in megawatts (i.e., the economic minimum), may be removed in line with the way the ISO treats these price points. Furthermore, in some cases where different prices are offered for the same MW value, the MW value associated with the higher price may be increased by 0.1 to account for data rounding by the ISO. This value is chosen because it allows one to meaningfully distinguish the bid blocks and is close to the ISO MW reported precision, which, depending on the market region, is either 0.1 or 0.01 MW.

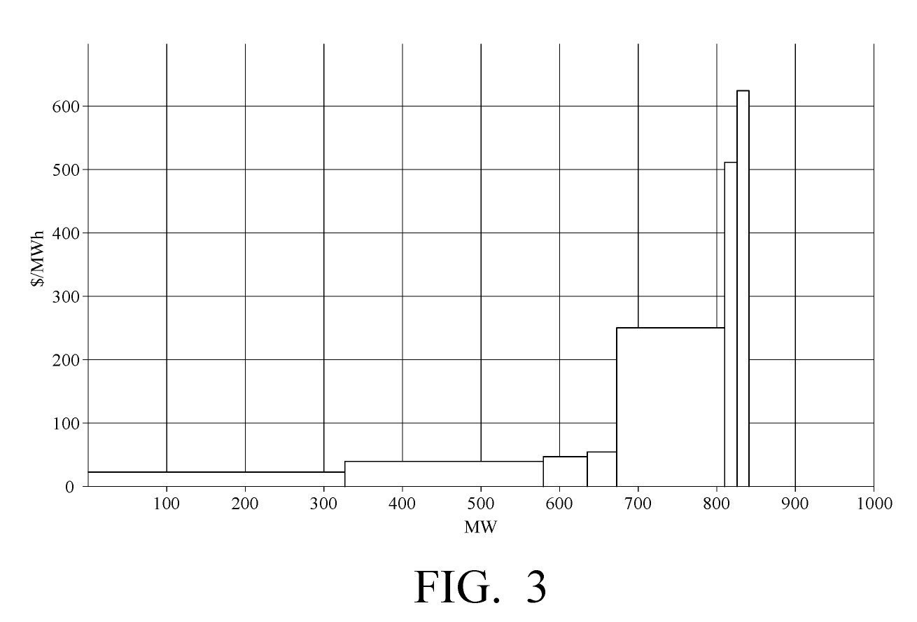

Referring again to FIG. 1, after all pre-processing routines have been completed, the result is a bid curve for each bidding entity. An exemplary bid curve is illustrated in FIG. 3.

In certain implementations of the present invention, it is then necessary to normalize bid curves among all of the bidding entities in a region, as indicated by block 108 of FIG. 1. For instance, the majority of bidding entities submit ten (10) bid blocks or fewer, even in instances where more bid blocks are allowed by the ISO (e.g., ERCOT). One such method of bid curve normalization thus normalizes all bid curves to ten (10) bid blocks or ten (10) points along the bid curve only. This reduces computational intensity when handling interpolated bid curves. A bid curve that is interpolation-eligible can be dispatched by the ISO at any point along the linear interpolation between adjacent submitted price points. When transforming the data, the method and system of the present invention captures this by splitting bid blocks in half to create more price points. While this process could be indefinitely applied, a limit of ten (10) is found to provide a balance between curve resolution and computation.

When handling cases where there are more than ten (10) bid blocks, the curves may be condensed to the same ten (10)-block limits. The lowest and highest MW bid blocks are maintained, as this preserves the offered operating limits of the power generator. The intervening eight (8) bid blocks are chosen from the bid blocks which vary the most in price from one block to another. In this way, the shape of the resultant bid curve preserves the overall shape of the original bid curve. Where there are fewer than ten (10) bid blocks, block 1 and block 10 are set as the EconMin and EconMax bids, respectively. The submitted bid blocks are then assigned blocks between 1 and 10. New blocks are added between existing blocks by calculating the slope between existing nearest neighbor blocks.

Referring again to FIG. 1, after all pre-processing routines have been completed and the bid curves have been normalized, the next step is to generate a bid prediction model, as indicated by block 112 of FIG. 1. The bid prediction model results from an analysis of the bid curves, combined with certain other data inputs. In other words, in order to profile bidding behavior for an individual bidding entity, the decoded and pre-processed bid data, now in the form of a bid curve (or curves) is collected and analyzed to determine what best represents the bidding strategy for a bidding entity. Normal bidding patterns can be identified using various methods to identify outliers in the data. For instance, using various types of external information (which is generally available from public sources), including, but not limited to, fuel prices, weather information (temperature), outage information, and/or any other information or data that might impact bidding strategies, bidding patterns can be identified that are associated with large changes in bidding, such as that sometimes seen with a change in generating asset ownership and operating structure to small changes resulting from outages or changes in local power generation fuel pricing. Various classifications of bidding behavior can be identified as normal or best matching a standard bidding strategy for a bidding entity. Using the historic bid data, outliers associated with outages or errors in data can be substantially eliminated. In addition, when matched to changes in ownership of generating assets, the history can be segmented into normal bidding strategy for each bidding entity. In this way, a subset of the historic dataset is segmented and defined as representing normal bidding strategy for the current owner of the generating assets.

Once bidding strategies are established for singular power plants or across fleets of generating assets, the derived bidding strategies can be used to compare and contrast bidding strategies among different power generators and used to evaluate and benchmark the efficient optimization of generating assets by any particular power generator.

For example, with respect to outage or disruption of generating units or similar information about power production, certain monitoring technology may be used to provide the information, such as that technology described in U.S. Pat. No. 6,771,058 entitled “Apparatus and Method for the Measurement and Monitoring of Electrical Power Generation and Transmission” and U.S. Pat. No. 6,714,000 entitled “Apparatus and Method for Monitoring Power and Current Flow,” each of which is incorporated herein by reference. The bid prediction model allows the prediction of the bid price for a given period of time if the generating unit is functioning during that period of time. If, by means of remotely monitoring the generating unit or other information sources, a unit is discovered to have an outage, the ISO will need to dispatch additional generation to replace the loss of generation. Since the ISO will start with lowest cost bids and dispatch generation at increasing cost until the projected demand level is met, the bid prediction model can also be used to predict what the likely replacement generation bid price was. Unexpected generating unit loss generally means that the cost to meet the same demand increases.

A result of this analysis is a bid prediction model for a particular bidding entity, as indicated by block 120 of FIG. 1, which is stored in a memory component of a computer. In practice, the bid prediction model is one or more equations, rules-based calculators, or rules-based reference tables which define how absolute bid amounts or a range of possible bid amounts vary as a function of factors influencing the bidding behavior (i.e., bidding patterns or bidding profile) of a bidding entity. These equations, rules-based calculators, or rules-based reference tables will be associated with a known series of generated power levels which can be produced by the bidding entity. For example, parameters which may influence bidding behavior and may be factored into the equations, rules-based calculators, or rules-based reference tables include, but are not limited to, fuel prices, weather information (temperature), and outage information. The bid prediction model (i.e., the equations, rules-based calculators, or rules-based reference tables) thus relates information, such as fuel prices, weather data, and/or generator outage data, to bid prices and generation values. Again, the bid prediction model for a particular bidding entity (i.e., the series of equations, rules-based calculators, or rules-based reference tables, along with weighting factors, etc.) is stored in a memory component of a computer.

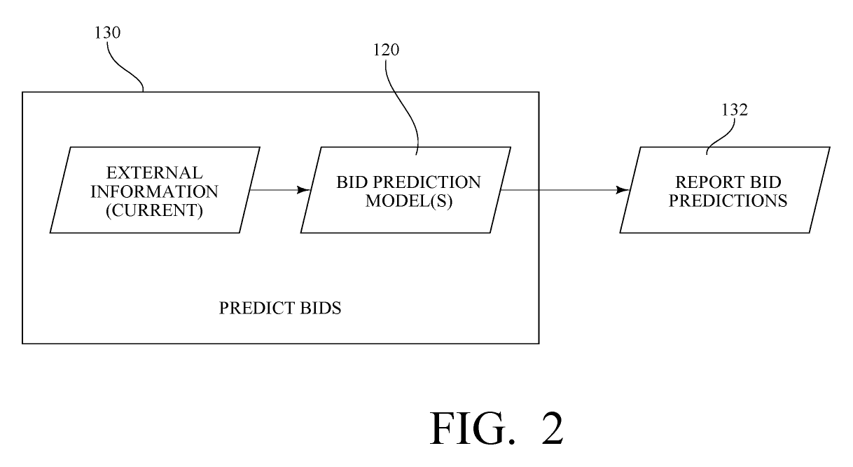

Referring now to FIG. 2, current external information (e.g., fuel prices, weather information, and/or outage information) is received and input into the one or more bid prediction models stored in the memory component for the various bidding entities. Each bid prediction model is applied to the current information to predict future bids for one or more bidding entities, as indicated by block 130 in FIG. 2. The resulting bid predictions are stored for further analysis or reported to market participants, as indicated by block 132 in FIG. 2.

As a further refinement, since the bid prediction models may be continuously re-generated, updated, and improved as new data and information is collected, it is also contemplated that changes in bidding patterns and bidding strategies for bidding entities can be identified and reported to market participants.

The above-described operational and computational steps of this method are preferably achieved through the use of a digital computer program (i.e., computer-readable instructions executed by a processor of a computer) that includes appropriate modules for executing the requisite instructions (which are stored in a memory component of the computer). Thus, an exemplary system 200 for analyzing and predicting bidding in an electric power marketplace in accordance with the present invention includes: (a) a bid data receiving module 202 for collecting and receiving bid data, which is then stored in a database 204; (b) a pre-processing module 206 for decoding the identity of the bidding entities from the bid data and/or to remove erroneous or noisy data; (c) a bid data normalization module 208 for normalizing bid curves among all of the bidding entities in a region, if necessary; (d) an information receiving module 210 for collecting and receiving external information relevant to the bid data, including, for example, fuel prices, weather information (temperature), outage information, and/or any other information or data that might impact bidding strategies, which is also stored in a database 212; (e) an analysis module 220 for (i) generating a bid prediction model from the bid data combined with the external information received via the information receiving module 210, and (ii) applying the bid prediction model against information that is subsequently received via the information receiving module 210 to predict future bids for one or more bidding entities; and (f) a reporting module 230 for reporting future bids for one or more bidding entities to market participants.

### Example

Exemplary bid data about a particular gas-fired generating unit is available from the Pennsylvania, Jersey, Maryland Power Pool (PJM). As reflected in Table B below, the published data includes:

TABLE B

| Column | Description |
|---|---|
| Date | Time period for the bid data. |
| Unitcode | Unique identifier for the bidding entity. |
| Bid1-Bid10 | Prices bid (in $/MWh) for each bid block |
| MW1-MW10 | Generation bid (in MW) for each bid block. |
| NoLoadCost | Cost bid to run the unit at the minimum output |
| | level. |
| Start Cost (Cold/Inter/ | Cost bid for startup of the bid entity. |
| Hot) | |
| EconMin (Min/Avg/ | Minimum economic operating level |
| Max) | over the course of the bid period. |
| EconMax (Min/Avg/ | Maximum economic operating level |
| Max) | over the course of the bid period. |
| UseBidSlope | Indicator flag for linearly interpolated |
| | pricing between submitted blocks. |

Referring again to FIG. 1, and as discussed above, such bid data is collected and then stored in a database, as indicated by blocks 102 and 104.

Referring still to FIG. 1, and as also discussed above, after the collection of bid data of interest, there is a pre-processing of that bid data, as indicated by block 106 of FIG. 1. In this regard, the bid data must be connected (or mapped) to a generating unit. As discussed above, the identity of a generating unit is usually masked in the published bid data. In order to unmask the identity, the published bid identity codes (Unitcode) are connected (or mapped) to generating units or decoded via a statistical semi-automatic process of elimination.

First, from year to year, the published bid identity codes (Unitcode) may change for a given ISO. Knowing this information, different codes in consecutive years can be matched together by looking for numerical similarities between the number of blocks bid, the amount of MW bid in each block, and the median price across all blocks in the last four days of the old code (Unitcode) and the first four days of the new code (Unitcode).

In order to connect (or match) bid identity codes to generating units, all available information on generating units in a given market region, including, but not limited to, owner, location, fuel type, generator age, generator type, and possible sources of fuel are collected from sources such as the Energy Information Administration (EIA), company reports, or elsewhere. Statistics are then compiled based on the published bid data, including, for example, the maximum amount bid, the median price, the amount of day-to-day variation, the economic minimum, and any outage dates on a monthly basis. Starting with the largest generating units, these collected statistics are matched to the compiled generating unit information to determine the best matches, and hence, identify the generating unit associated with each bid code. In this regard, the collected statistics inform things such as the fuel a generating unit most likely burns, how large a generating unit is, whether a generating unit is subject to seasonal thermal de-rating, and what unique periods (such as outages) might tie a generating unit to an actual reported outage. The smaller the generating units get, the more difficult it becomes to correctly match and differentiate; however, a large number of physical generating units can be matched, so the bid prediction models (as further discussed below) encompass the greatest amount of generation capacity possible.

In order to verify the connection or matching of a bid identity code to a generating unit (or bid-unit mapping), an assigned bid-unit mapping can be compared with the historical location marginal pricing (LMP) at the nearest price node for the generating unit, confirming that this matches up with the generation data at the same time as reported to the Environmental Protection Agency (EPA) as part of a Continuous Emission Monitoring System (CEMS).

Returning to the present example and the pre-processing of the bid data, an excerpt of the collected data is presented in Table C below, where the bid data is organized such that the “Bid” and “MW” columns share the same number as a pair (i.e., Bid1 with MW1, Bid2 with MW2, etc.). In this excerpt, bid data is presented for a nine-day time period, although it is certainly contemplated and preferred to have a much larger data set for the subsequent analysis and modeling.

TABLE C

| Date | Bid1 | Bid2 | Bid3 | Bid4 | MW1 | MW2 | MW3 | MW4 | EconMin | EconMax |
|---|---|---|---|---|---|---|---|---|---|---|
| 2016 Aug. 1 | 24.64 | 24.97 | 25.64 | 31.73 | 600.00 | 610.00 | 716.00 | 738.00 | 600.00 | 741.00 |
| 2016 Aug. 2 | 24.93 | 25.26 | 25.93 | 32.55 | 600.00 | 610.00 | 715.00 | 738.00 | 600.00 | 741.00 |
| 2016 Aug. 3 | 24.57 | 24.90 | 25.57 | 32.92 | 600.00 | 610.00 | 711.00 | 734.00 | 600.00 | 739.00 |
| 2016 Aug. 4 | 22.16 | 22.49 | 23.16 | 32.46 | 600.00 | 610.00 | 708.00 | 732.00 | 600.00 | 737.00 |
| 2016 Aug. 5 | 22.16 | 22.49 | 23.16 | 29.36 | 600.00 | 610.00 | 706.00 | 731.00 | 600.00 | 734.00 |
| 2016 Aug. 6 | 22.16 | 22.49 | 23.16 | 29.36 | 600.00 | 610.00 | 714.00 | 736.00 | 600.00 | 743.00 |
| 2016 Aug. 7 | 22.37 | 22.70 | 23.37 | 29.36 | 600.00 | 610.00 | 720.00 | 742.00 | 600.00 | 745.00 |
| 2016 Aug. 8 | 23.01 | 23.34 | 24.01 | 29.63 | 600.00 | 610.00 | 711.00 | 735.00 | 600.00 | 740.00 |
| 2016 Aug. 9 | 22.80 | 23.13 | 23.80 | 30.45 | 600.00 | 610.00 | 710.00 | 734.00 | 600.00 | 737.00 |

In this example, the bid data is first examined for format inconsistencies and invalid values, and if such inconsistencies or invalid values are identified, such data may be discarded or re-formatted.

First, Bid-MW pairs are eliminated where both the Bid value and MW value are 0 or NULL. If, for example, Bid1 and MW1 are both 0, or are both empty, these data values are deleted and other Bid-MW pairs fill their place. For instance, old Bid2 now becomes Bid1, old MW2 becomes MW1, and so on. If no Bid-MW pairs are remaining, the data row is deleted and is not used in the subsequent analysis.

Secondly, the data is examined to ensure that the Bid values are increasing from Bid1 to the highest value, and similarly, that the MW values are increasing from MW1 to the highest value. Specifically:

If MW(n+1)=MW(n), add 0.1 to MW(n+1); account for possible data rounding.

If MW(n+1)<MW(n), delete MW(n+1) and Bid(n+1); bad data.

If Bid(n+1)<Bid(n), set Bid(n+1)=Bid(n); ensures that the bid values are either flat or increasing.

Thirdly, Bid and MW values are eliminated where the value is greater than the market cap level for the region. For example, in PJM, this market cap value is currently $1,200.

Additionally, in the present example, with respect to pre-processing, the bid data is further examined to ensure that it matches or is within economic limits.

First, Bid-MW pairs are eliminated where the MW value is less than the economic minimum (EconMin) submitted for the time period. In this regard, a generating unit will not be tasked to operate below its submitted economic minimum (EconMin), so it is safe to ignore these bid blocks as irrelevant.

Secondly, if the maximum MW value submitted is greater than the economic maximum (EconMax) submitted for the time period, find the smallest MW value that is greater than or equal to the economic maximum (EconMax), and set this value as EconMax. Then, eliminate all Bid-MW pairs with a MW value that is still greater than EconMax.

Thirdly, if the maximum MW value submitted is not greater than the economic maximum (EconMax), set the maximum MW value to EconMax.

After the above steps have been completed, in the continuing pre-processing of the bid data, the bid-MW pairs are removed in the cases where the MW value is 0. This might occur as a result of the previous steps, if the economic maximum (EconMax) was bid as 0, but this indicates that the generating unit was not economically available, and therefore, the data is removed.

In the present example, as part of pre-processing, further checks may then also be performed. For instance, the bid data may be examined to confirm that there are no duplicate dates or that there are more than a predetermined number of bid blocks for a particular date.

In the present example, as part of pre-processing, outliers may also be removed. For instance, bid data may be removed when the economic maximum (EconMax) does not meet the capacity market obligation. In this regard, operators of generating units are penalized financially for not bidding their obligated capacity when not on outage or de-rate, so these days are treated as outliers and removed from the analysis. For another example, a threshold may be set to remove data as outliers when a power generating unit would be operating significantly below capacity, such as on days when the unit is significantly de-rated or on outage.

As described above with reference to FIG. 1, after all pre-processing routines have been completed, the result is a bid curve for each bidding entity. In this example, the data in Table C represents this bid curve.

Referring again to FIG. 1, the next step is to generate a bid prediction model, as indicated by block 112 of FIG. 1. The bid prediction model results from an analysis of the bid curve, combined with certain external information or data inputs.

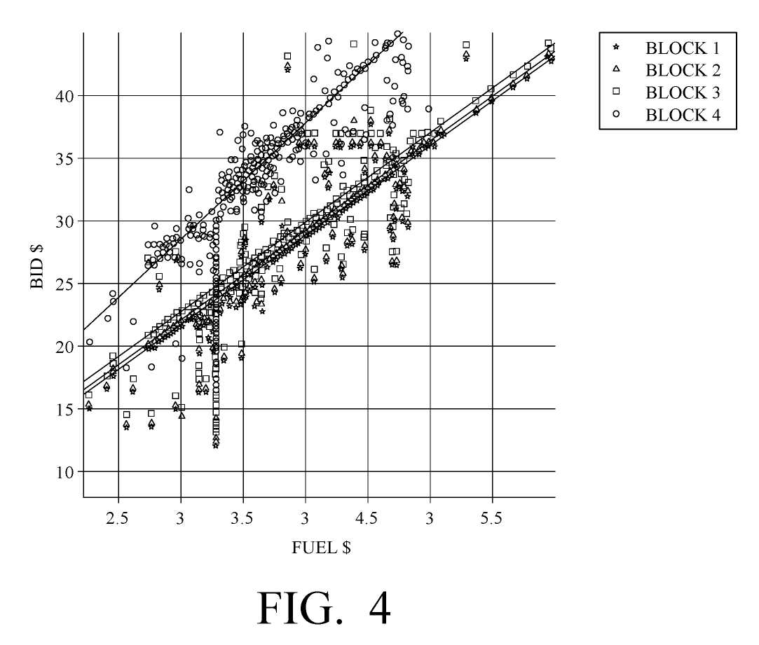

In this example, a first bid prediction model is generated in which a bid amount is the dependent variable, and the other data input (independent variable) is the fuel price in the region for each day of the same time period. FIG. 4 is a plot of bid block prices (Bid1, Bid2, Bid3, Bid4) against fuel prices. As mentioned above, Table C provides only an excerpt of the collected data, and significantly more data points are included in the plot in FIG. 4. As illustrated in FIG. 4, there is a linear relationship between the bid amount and the fuel price. In short, when the fuel price increases, the bid amount increases, and vice versa. In this example, an iteratively weighted least-squares regression is thus applied to these data points, resulting in a linear model (or equation) that relates the bid amount to the fuel price. As mentioned above, this bid prediction model is then stored in a memory component of a computer

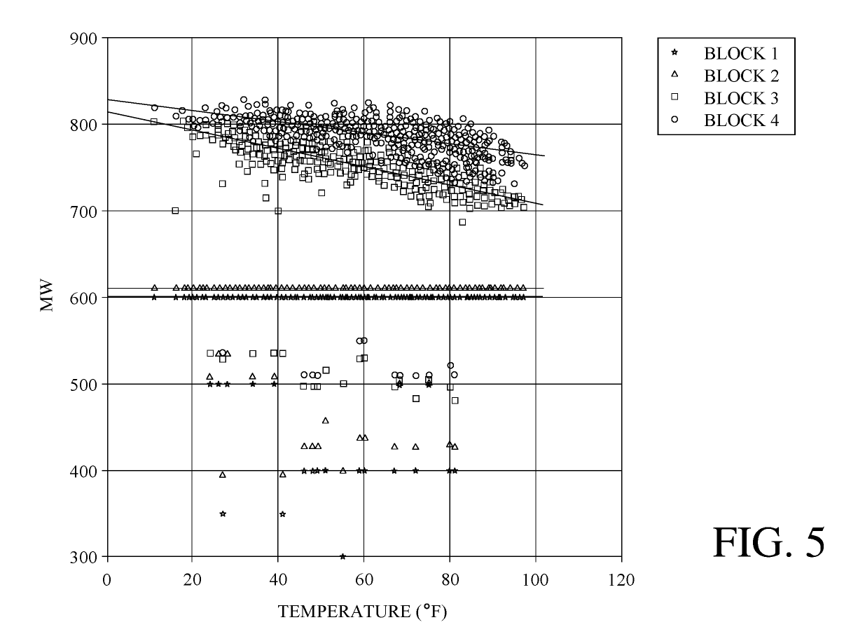

In this example, a second bid prediction model is generated in which a generation value (MW) is the dependent variable, and the other data input (independent variable) is the temperature for each day of the same time period. FIG. 5 is a plot of bid block generation values (MW1, MW2, MW3, MW4) against temperature. As mentioned above, Table C provides only an excerpt of the collected data, and significantly more data points are included in the plot in FIG. 5. As illustrated in FIG. 5, it appears that the temperature has no effect when the generation value is below 610 MW. However, at higher generation values, increasing temperatures result in decreased generation values. In other words, at higher temperatures, the power generating units are not able to generate at the same level, and this is reflected in the bid data. In any event, an iteratively weighted least-squares regression (or similar optimization routine) is thus applied to these data points, resulting in a model (or equation) that relates the generation value to the temperature. As mentioned above, this bid prediction model is then stored in a memory component of a computer.

The two bid prediction models described above are just examples of how bid data can be related and modeled against external information. As mentioned above, the external information may include not only fuel prices and weather information (temperature), but also outage information and/or any other information or data that might impact bidding strategies. Furthermore, as mentioned above, the bid prediction model may be comprised of one or more equations, rules-based calculators, or rules-based reference tables; thus, multi-variable and more complex bid prediction models can also be generated without departing from the spirit and scope of the present invention.

Returning to the present example, and referring again to FIG. 2, once the one or more bid prediction models have been stored, as current external information (e.g., fuel prices, weather information, and/or outage information) is received, that external information is input into the bid prediction models. Each bid prediction model is applied to the external information to predict future bids for the bidding entity, as indicated by block 140 in FIG. 2. In other words, the output from the bid prediction model(s) is a prediction of the prices (in $/MWh) and the generation values (in MW) that the operator of this particular gas-fired generating unit will submit for the upcoming auction.

Finally, the resulting bid predictions are stored for further analysis or reported to market participants or other third parties, as indicated by block 142 in FIG. 2. With respect to such reporting, by making bid predictions for all generating units in a particular ISO, it is also possible to report the variability in bid amount to be expected from a particular generating unit relative to the others participating in the market. When one or more generating units then experience outages, the relative effect compared to generating units that remain online can be assessed, as well as the relative effect of an outage to other generating unit outages occurring at the same time in the marketplace. In this regard, it is not uncommon for multiple generating units to experience unexpected outages due to mechanical or other failures during any given market day. Furthermore, once bidding patterns have been identified, deviations or irregularities can also be readily identified and reported.

One of ordinary skill in the art will recognize that additional embodiments and implementations are also possible without departing from the teachings of the present invention. This detailed description, and particularly the specific details of the exemplary embodiments and implementations disclosed therein, is given primarily for clarity of understanding, and no unnecessary limitations are to be understood therefrom, for modifications will become obvious to those skilled in the art upon reading this disclosure and may be made without departing from the spirit or scope of the invention.

What is claimed is:

1. A method for predicting future bids of one or more bidding entities in an electric power marketplace, comprising the steps of:
collecting bid data for the one or more bidding entities in a selected region;
collecting external information relevant to the bid data;
generating a bid prediction model for the one or more bidding entities in the region from the bid data and the external information relevant to the bid data, and storing the bid prediction model in a memory component of a computer;
subsequently receiving external information and applying the bid prediction model, as stored in the memory component of the computer, to the external information to predict future bids for the one or more bidding entities; and
reporting the predicted future bids to a market participant.

2. The method as recited in claim 1, and further comprising the step of pre-processing the bid data to decode the identity of each of the one or more bidding entities;

3. The method as recited in claim 2, in which the step of pre-processing the bid data further includes removal of erroneous data.

4. The method as recited in claim 1, and further comprising the step of normalizing the bid data across the bidding entities in the region.

5. The method as recited in claim 1, wherein the external information is fuel prices.

6. The method as recited in claim 1, wherein the external information is weather information.

7. The method as recited in claim 6, wherein the weather information includes temperature readings.

8. The method as recited in claim 1, wherein the external information is outage information.

9. A computer-based method for predicting future bids of one or more bidding entities in an electric power marketplace, comprising the steps of:
collecting bid data for the one or more bidding entities in a selected region, and storing that bid data in a memory component of a computer;
using the computer to process the bid data to decode the identity of the one or more bidding entities;
collecting external information relevant to the bid data, and storing that external information in the memory component of the computer;
using the computer to generate a bid prediction model for the one or more bidding entities in the region from the bid data and the external information relevant to the bid data, and storing the bid prediction model in the memory component of the computer;
subsequently receiving external information, and then using the computer to apply the bid prediction model to the external information to predict future bids for the one or more bidding entities; and
reporting the predicted future bids to a market participant.

10. A system for predicting future bids of one or more bidding entities in an electric power marketplace, comprising:
a bid data receiving module for collecting and receiving bid data for the one or more bidding entities, which is stored in a database;
an information receiving module for collecting and receiving external information relevant to the bid data, which is stored in a database;
an analysis module for
(i) generating a bid prediction model from the bid data and the external information received via the information receiving module, and
(ii) applying the bid prediction model against information that is subsequently received via the information receiving module to predict future bids for one or more bidding entities; and
a reporting module for reporting the future bids for one or more bidding entities to a market participant.

11. The system as recited in claim 10, and further comprising a pre-processing module for decoding an identity of each of the bidding entities from the bid data.

12. The system as recited in claim 10, wherein the external information is fuel prices.

13. The system as recited in claim 10, wherein the external information is weather information.

14. The system as recited in claim 13, wherein the weather information includes temperature readings.

15. The system as recited in claim 10, wherein the external information is outage information.
